(19) United States
(12) Patent Application Publication
(10) Pub. No.: US 2026/0260658 A1
(43) Pub. Date: Sep. 3, 2026

(54) SPEECH RECOGNITION METHOD AND SPEECH RECOGNITION APPARATUS

(71) Applicant: SHARP KABUSHIKI KAISHA, Sakai CIty (JP)

(72) Inventors: Eri AONO, Sakai City (JP); Noriko Hata, Sakai City (JP)

(21) Appl. No.: 19/551,956

(22) Filed: Feb. 27, 2026

(30) Foreign Application Priority Data
Feb. 28, 2025 (JP) 2025-031892

(51) Int. Cl. G10L 17/06; G10L 17/02; G10L 17/04

(52) U.S. Cl. CPC G10L 17/06; G10L 17/02; G10L 17/04

(57) ABSTRACT

A speech recognition method includes: an input speech data acquisition step of acquiring input speech data; an adjustment step of adjusting a first threshold based on a predetermined condition; and an identification step of comparing the input speech data or processed input speech data generated by processing the input speech data with registered speech data of speech of registrants registered in advance to calculate similarities for the respective registrants, and identifying which of the registrants registered in advance has made a speech corresponding to the input speech data or the processed input speech data based on the similarities, wherein the identification step includes registering the speaker of the input speech data or the processed input speech data as a new speaker when a largest value of the similarities calculated for the respective registrants is determined to be lower than the first threshold.

### CROSS-REFERENCE TO RELATED APPLICATION

The present application claims priority from Japanese Application JP2025-031892, the content to which is hereby incorporated by reference into this application.

### BACKGROUND OF THE INVENTION

### 1. Field of the Invention

The disclosure relates to a speech recognition method and a speech recognition apparatus.

### 2. Description of the Related Art

A speech recognition method is known in which, when a speaker is a newly recognized speaker, the speaker and a recognition parameter are stored in association with each other.

### SUMMARY OF THE INVENTION

Unfortunately, with the known speech recognition method, it is difficult to determine whether the speaker is a new speaker.

The disclosure is made in view of such circumstances, and provides a speech recognition method capable of improving accuracy of determination on whether a speaker is a new speaker.

The disclosure provides a speech recognition method including: an input speech data acquisition step of acquiring input speech data; an adjustment step of adjusting a first threshold based on a predetermined condition; and an identification step of comparing the input speech data or processed input speech data generated by processing the input speech data with registered speech data of speech of registrants registered in advance to calculate similarities for the respective registrants, and identifying which of the registrants registered in advance has made a speech corresponding to the input speech data or the processed input speech data based on the similarities, wherein the identification step includes registering the speaker of the input speech data or the processed input speech data as a new speaker when a largest value of the similarities calculated for the respective registrants is determined to be lower than the first threshold.

With the speech recognition method of the disclosure, the threshold can be manually or automatically adjusted according to a speech recognition condition, and accuracy of determination on whether the speaker is a new speaker can be improved.

### BRIEF DESCRIPTION OF THE DRAWINGS

FIG. 1 is a flowchart of a speech recognition method according to an embodiment of the disclosure.

FIG. 2 is a block diagram illustrating a configuration of a speech recognition apparatus according to the embodiment of the disclosure.

FIG. 3 is a flowchart of a speech recognition method according to an embodiment of the disclosure.

FIG. 4 is a flowchart of a speech recognition method according to an embodiment of the disclosure.

FIG. 5 is a flowchart of a speech recognition method according to an embodiment of the disclosure.

### DETAILED DESCRIPTION OF THE INVENTION

A speech recognition method of the disclosure includes: an input speech data acquisition step of acquiring input speech data; an adjustment step of adjusting a first threshold based on a predetermined condition; and an identification step of comparing the input speech data or processed input speech data generated by processing the input speech data with registered speech data of speech of registrants registered in advance to calculate similarities for the respective registrants, and identifying which of the registrants registered in advance has made a speech corresponding to the input speech data or the processed input speech data based on the similarities, wherein the identification step includes registering the speaker of the input speech data or the processed input speech data as a new speaker when a largest value of the similarities calculated for the respective registrants is determined to be lower than the first threshold. The speech recognition method of the disclosure may be a speaker identification method.

Preferably, the identification step is a step of comparing a numerical vector obtained by converting a feature of the input speech data or the processed input speech data with a numerical vector obtained by converting the registered speech data to calculate the similarities for the respective registrants, and identifying which of the registrants registered in advance has made the speech corresponding to the input speech data or the processed input speech data based on the similarities, and a step of registering the speaker of the input speech data or the processed input speech data as a new speaker when the largest value of the similarities calculated for the respective registrants is determined to be lower than the first threshold.

Preferably, the speech recognition method of the disclosure further includes an operation detection step of detecting an operation of adjusting the first threshold by a user, and the adjustment step includes adjusting the first threshold based on the operation of adjusting the first threshold by the user.

Preferably, the speech recognition method of the disclosure further includes a reliability determination step of determining reliability of speech recognition for the input speech data or the processed input speech data, and the adjustment step includes automatically adjusting the first threshold according to the reliability of the speech recognition.

Preferably, the speech recognition method of the disclosure further includes a running time determination step of determining whether a running time of the input speech data or a running time of the processed input speech data is longer than a second threshold, and the speaker of the input speech data or the processed input speech data is registered as a new speaker when the running time of the input speech data or the running time of the processed input speech data is determined to be longer than the second threshold in the determination step, and when the largest value of the similarities calculated for the respective registrants is determined to be lower than the first threshold in the identification step.

Preferably, the identification step includes determining the speaker of the input speech data or the processed input speech data to be unknown when the largest value of the similarities calculated for the respective registrants is higher than the first threshold and lower than a third threshold, and identifying the speaker of the input speech data or the processed input speech data as the registrant with the similarity of the largest value when the largest value of the similarities calculated for the respective registrants is higher than the third threshold.

Preferably, the speech recognition method of the disclosure further includes a reliability determination step of determining reliability of speech recognition for the input speech data or the processed input speech data, and the adjustment step includes automatically adjusting the first threshold and the third threshold according to the reliability of the speech recognition.

Preferably, the processed input speech data is data generated by removing speech data of a silent part from the input speech data. Preferably, the speech recognition method of the disclosure further includes a speaker integration step of integrating the new speaker into the registrants registered in advance, and the adjustment step includes automatically adjusting the first threshold to decrement the first threshold when number of times of integrating the new speaker into the registrants registered in advance exceeds a predetermined number of times.

The disclosure further provides a speech recognition apparatus including: an input speech data acquirer that acquires input speech data; an adjuster that adjusts a first threshold based on a predetermined condition; and an identifier that compares the input speech data or processed input speech data generated by processing the input speech data with registered speech data of speech of registrants registered in advance to calculate similarities for the respective registrants, and identifies which of the registrants registered in advance has made a speech corresponding to the input speech data or the processed input speech data based on the similarities, wherein the identifier registers the speaker of the input speech data or the processed input speech data as a new speaker when a largest value of the similarities calculated for the respective registrants is determined to be lower than the first threshold.

The disclosure will be described in more detail below with reference to a plurality of embodiments. Configurations illustrated in the drawings and the following description are examples, and the scope of the disclosure is not limited to the configurations illustrated in the drawings or the following description.

### First Embodiment

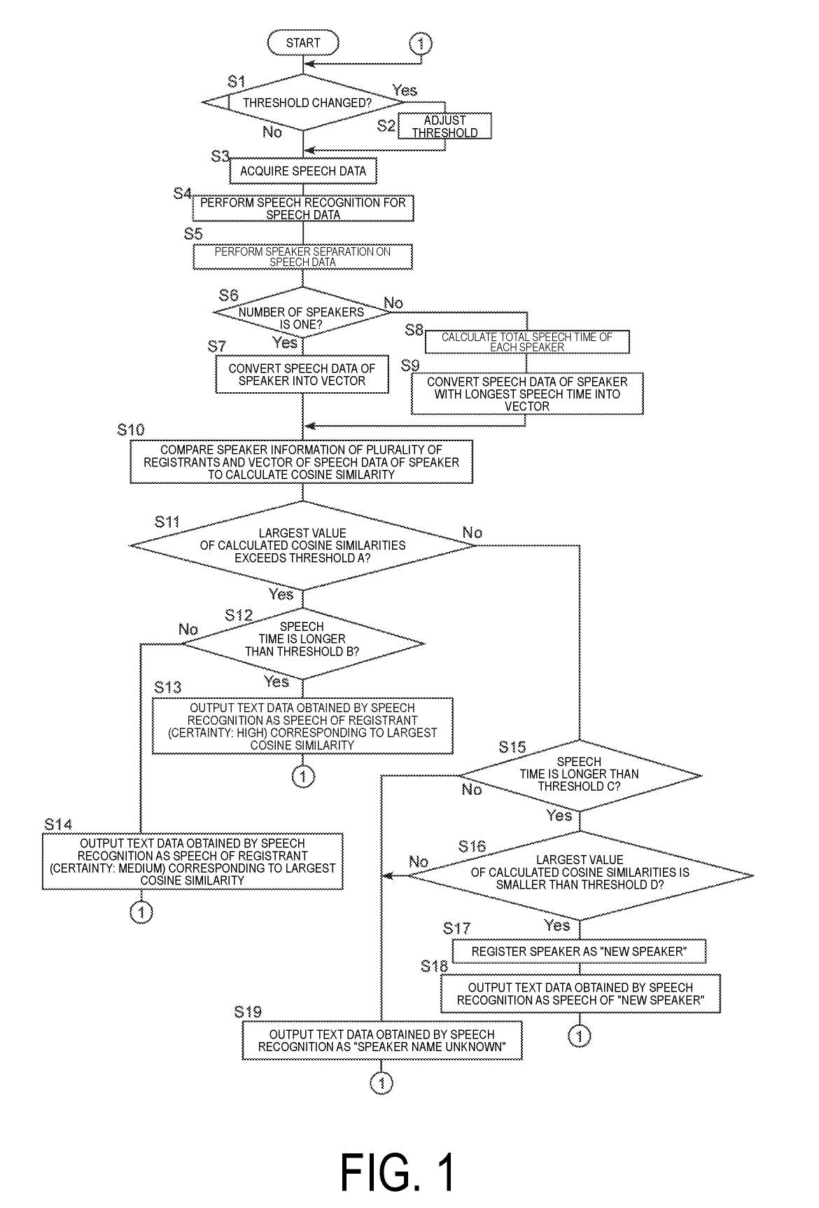

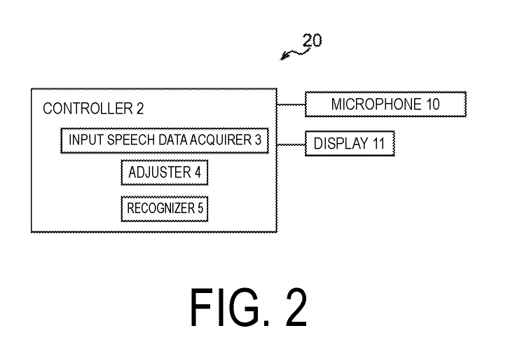

FIG. 1 is a flowchart of a speech recognition method according to a first embodiment, and FIG. 2 is a block diagram illustrating a configuration of a speech recognition apparatus.

The speech recognition method of the first embodiment includes: an input speech data acquisition step (for example, step S3) of acquiring input speech data; an adjustment step (for example, step S2) of adjusting a first threshold based on a predetermined condition; and an identification step (for example, steps S7, S9 to S11, S16, and the like) of comparing the input speech data or processed input speech data generated by processing the input speech data with registered speech data of speech of registrants registered in advance to calculate similarities for the respective registrants, and identifying which of the registrants registered in advance has made a speech corresponding to the input speech data or the processed input speech data based on the similarities. The identification step includes registering the speaker of the input speech data or the processed input speech data as a new speaker when a largest value of the similarities calculated for the respective registrants is determined to be lower than the first threshold (for example, step S17).

The speech recognition method according to the first embodiment further includes an operation detection step (for example, step S1) of detecting an operation of adjusting the first threshold by a user, wherein the adjustment step (for example, step S2) includes adjusting the first threshold based on the operation of adjusting the first threshold by the user. Note that step S15 is a running time determination step.

The speech recognition method of the first embodiment can be implemented by, for example, a speech recognition apparatus 20 as illustrated in FIG. 2.

The speech recognition apparatus 20 according to the first embodiment includes: an input speech data acquirer 3 that acquires input speech data; an adjuster 4 that adjusts a first threshold based on a predetermined condition; and an identifier 5 that compares the input speech data or processed input speech data generated by processing the input speech data with registered speech data of speech of registrants registered in advance to calculate similarities for the respective registrants, and identifies which of the registrants registered in advance has made a speech corresponding to the input speech data or the processed input speech data based on the similarities, wherein the identifier 5 registers the speaker of the input speech data or the processed input speech data as a new speaker when a largest value of the similarities calculated for the respective registrants is determined to be lower than the first threshold.

The speech recognition apparatus 20 may include a controller 2, and the input speech data acquirer 3, the adjuster 4, and the identifier 5 may be programs included in the controller 2. The controller 2 may include an outputter. The speech recognition apparatus 20 may include a microphone 10, a display 11, an operation inputter, and the like. The speech recognition apparatus 20 may be connected to a computer (user interface) in a wired or wireless manner. The speech recognition apparatus 20 may be connected to a computer (user interface) via a network such as a LAN. In this case, a monitor of the computer can be used as the display 11. The user can also input the name and the like of a speaker using the computer.

The speech recognition apparatus 20 may be included in a speech recognition-based automatic minutes system, a speech recognition-based conversation recording system, or a speech-to-text system. The controller 2 can include a processor, a storage, a communicator, and the like. The processor can include, for example, at least one of a CPU, an MPU, a GPU, an NPU, and the like. The storage is a RAM, a storage, or the like. The communicator is a component provided so as to be connected to the Internet, a local area network, or the like.

The controller 2 can be connected to the microphone 10 so that a speech signal output from the microphone 10 can be input.

Further, the controller 2 (outputter) can be connected to a user interface such as the display 11 so that a recognition result of the speech recognition method of the embodiment can be output to the user interface.

A specific example of the speech recognition method of the first embodiment will be described with reference to a flowchart illustrated in FIG. 1.

In step S1, the controller 2 determines whether a threshold has been changed. This threshold includes, for example, at least one of a threshold A used in step S11, a threshold B used in step S12, a threshold C used in step S15, and a threshold D used in step S16. The speech identification method according to the embodiment may include a selection step of allowing a user to select a "mode of lenient speaker similarity determination" or a "mode of strict speaker similarity determination". The threshold to be set differs depending on the mode selected. When the controller 2 detects that the user has not changed the mode in step S1, the processing proceeds to step S3. When the controller 2 detects that the user has changed the mode in step S1, the processing proceeds to step S2.

In step S2, the controller 2 (adjuster 4) adjusts the threshold. For example, when the controller 2 detects that the mode has changed in step S1, the controller 2 adjusts in step S2, at least one of the threshold A used in step S11, the threshold B used in step S12, the threshold C used in step S15, and the threshold D used in step S16, in accordance with the mode. This allows the user to change a similarity determination criterion according to the situation, thereby improving the accuracy of speaker identification. Thereafter, the processing proceeds to step S3.

In step S3, the controller 2 (input speech data acquirer 3) acquires input speech data from the microphone 10 or the like. In step S3, the controller 2 may detect a speech period using voice activity detection (VAD) and acquire speech data in this speech period as input speech data. In addition, in step S3, the controller 2 may acquire, as processed input speech data, speech data obtained by accumulating and combining pieces of the input speech data and removing silent parts. For example, the controller 2 can determine whether each piece of speech data is a silent part, and can create the processed input speech data by excluding the speech data of the silent part from the speech data to be combined.

In step S4, the controller 2 performs speech recognition on the input speech data or the processed input speech data, and acquires text data corresponding to the input speech data or the processed input speech data. For example, the controller 2 can execute the speech recognition processing using an AI model. When the controller 2 stores the AI model, the controller 2 can execute the speech recognition processing. Further, the controller 2 may transmit the input speech data to a server on the Internet or a local area network via the communicator, the speech recognition processing may be performed in the server, and a result thereof may be received via the communicator.

In the speech recognition processing, text data is generated from the input speech data or the processed input speech data by executing filtering processing such as speech determination (VAD determination), language determination, determination on certainty of recognition results, and text shaping (removing hallucination such as symbols).

In step S5, the controller 2 executes speaker separation processing on the input speech data or the processed input speech data. In the speaker separation processing, when the speech data includes only a speech of one speaker, the speech period of one speaker included in the speech data is detected, and when the speech data includes speeches of a plurality of speakers, the speech period of each speaker included in the speech data is detected. For example, when the speech data includes a speech of a speaker A, a speech of a speaker B, a speech of the speaker A, a speech of a speaker C, and a speech of the speaker B in this order, the controller 2 detects a period of the first speech of the speaker A, a period of the first speech of the speaker B, a period of the second speech of the speaker A, a period of a speech of the speaker C, and a period of the second speech of the speaker B. The controller 2 can execute the speaker separation processing using, for example, a speaker separation AI model. When the controller 2 stores the AI model, the controller 2 can execute the speaker separation processing. Further, the controller 2 may transmit the input speech data to a server on the Internet or a local area network via the communicator, the speaker separation processing may be executed in the server, and a result thereof may be received via the communicator.

In step S6, the controller 2 determines whether the number of speakers of the speech included in the input speech data or the processed input speech data is one or not.

When the controller 2 determines that the number of speakers is one in step S6, the processing proceeds to step S7, and the controller 2 (identifier 5) executes processing of vectorizing the input speech data or the processed input speech data (for example, Embedding calculation). Then, the processing proceeds to step S10.

When the controller 2 determines that the number of speakers is more than one in step S6, the controller 2 calculates the total speech time of each speaker included in the input speech data or the processed input speech data in step S8. Then, the processing proceeds to step S9, and the controller 2 (identifier 5) executes the processing of vectorizing the speech data of the speaker having the longest total speech time included in the input speech data or the processed input speech data (for example, Embedding calculation). Then, the processing proceeds to step S10.

In step S10, the controller 2 (identifier 5) compares the speaker information of a plurality of registrants stored in the storage with the vector of the input speech data or the vector of the processed input speech data generated in step S7 or S9, and calculates the similarity (for example, cosine similarity).

The storage of the controller 2 stores speaker information of a plurality of registrants. For example, the storage of the controller 2 stores the speech data of a registrant and the vector thereof as the speaker information together with the name of the registrant. The speaker information may be stored in the storage before the speech recognition method of the embodiment is performed, or the speaker information may be stored in the storage while the speech recognition method of the embodiment is repeated.

The cosine similarity takes a value within a range of -1 to 1, and is used to calculate the relevance or similarity between pieces of vectorized speech data. Regarding the cosine similarity, similarity between the vectors of two pieces of speech data is determined to be higher, with a smaller angle between the two vectors, that is, with a value closer to 1.

In step S10, for example, the controller 2 (identifier 5) compares the vector of the input speech data or the vector of the processed input speech data generated in step S7 or S9 with the vector of the speech data of each registrant stored in the storage, and calculates the cosine similarity for each registrant.

In step S11, the controller 2 (identifier 5) determines whether the largest value of all the cosine similarities calculated in step S10 exceeds the threshold A. The threshold A may be set to the smallest value of a range of the cosine similarities with which the speaker of the input speech data or the processed input speech data can be regarded as the same person as the registrant. When the threshold A is set to be high, the speaker will not be regarded as the same person as the registrant unless the similarity is high, and thus the similarity determination becomes strict, whereby determination of different persons as the same person by the controller 2 can be suppressed. For example, when the user selects the "mode of strict speaker similarity determination", the controller 2 can set the threshold A to be higher than that under the "mode of lenient speaker similarity determination" in step S2.

When the threshold A is set to be low, determination of the speech of the same speaker as the speech of different speakers by the controller 2 can be suppressed. For example, when the user selects the "mode of lenient speaker similarity determination", the controller 2 can set the threshold A to be lower than that under the "mode of strict speaker similarity determination" in step S2. These modes can be selected by the user according to the situation.

When the controller 2 (identifier 5) determines that the largest value of all the cosine similarities exceeds the threshold A in step S11, the controller 2 determines in step S12, whether the speech time of the input speech data or the processed input speech data acquired in step S1 is longer than the threshold B. The threshold B may be the smallest value of the speech time required for determining that the speaker is the same person as the registrant based on the cosine similarity. This threshold B can be adjusted (changed) in step S2. When the controller 2 determines that the speech time is longer than the threshold B in step S12, the processing proceeds to step S13, and the controller 2 outputs the text data obtained by the speech recognition in step S4 as the speech of the registrant corresponding to the largest cosine similarity to the user interface such as the display 11. The controller 2 also outputs, to the user interface, information indicating that the certainty of the speech of the relevant registrant is high. Specifically, both the name of the registrant corresponding to the largest cosine similarity and the text data obtained by the speech recognition in step S4 can be displayed on the display 11. At this time, the controller 2 can display the name of the registrant and the information indicating that the certainty is high on the display 11. For example, the controller 2 may not display a question mark (?) together with the name of the registrant. Then, the processing returns to step S1.

When the controller 2 determines that the speech time is shorter than the threshold B in step S12, the processing proceeds to step S14, and the controller 2 outputs the text data obtained by the speech recognition in step S4 as the speech of the registrant corresponding to the largest cosine similarity to the user interface such as the display 11. The controller 2 also outputs, to the user interface, information indicating that the certainty of the speech of the relevant registrant is relatively low. Specifically, both the name of the registrant corresponding to the largest cosine similarity and the text data obtained by the speech recognition in step S4 can be displayed on the display 11. At this time, the controller 2 can display the name of the registrant and the information indicating that the certainty is relatively low on the display 11. For example, the controller 2 can display a question mark (?) together with the name of the registrant. Then, the processing returns to step S1.

When the controller 2 (identifier 5) determines that the largest value of all the cosine similarities is smaller than the threshold A in step S11, whether the speech time of the input speech data or the processed input speech data is longer than the threshold C is determined in step S15. The threshold C may be the smallest value of the speech time required for determining whether the speaker is the same person as the registrant based on the cosine similarity. This threshold C can be adjusted (changed) in step S2.

When the controller 2 determines that the speech time of the input speech data or the processed input speech data is shorter than the threshold C in step S15, the controller 2 outputs the text data obtained by the speech recognition in step S4 as "speaker name unknown" to the user interface such as the display 11 in step S19. In this case, the user can input the name of the speaker to the controller 2, or can select the name of a registrant who has already been registered, using an operation inputter such as a keyboard. When the name of the speaker is input or the name of the registrant is selected, the controller 2 corrects the display of "speaker name unknown" on the user interface to the input name of the speaker or the selected name of the registrant.

When the name of the speaker input by the user is not registered, the controller 2 stores the input speech data or the processed input speech data acquired in step S3, the vector of the speech data generated in step S7 or S9, and the input name in the storage as speaker information. This speaker information can be used as speaker information of the registrant in the subsequent step S10.

When the name of the speaker input by the user has already been registered or when the user selects the name of a registrant who has already been registered, the controller 2 can integrate the input speech data or the processed input speech data acquired in step S3 and the vector of the speech data generated in step S7 or S9 into the speaker information of the registrant and store the integrated information in the storage.

Then, the processing returns to step S1.

When the controller 2 determines that the speech time of the input speech data or the processed input speech data is longer than the threshold C in step S15, the controller 2 determines whether the largest value of all the cosine similarities calculated in step S10 is smaller than the threshold D in step S16. The threshold D may be set to the largest value of the range of the cosine similarities with which the speaker of the input speech data or the processed input speech data can be regarded as a person different from any of the registrants. This threshold D can be adjusted (changed) in step S2.

When the controller 2 determines that the largest value of all the cosine similarities exceeds the threshold D in step S16, the controller 2 outputs the text data obtained by the speech recognition in step S4 as "speaker name unknown" to the user interface such as the display 11 in step S19. Then, the processing returns to step S1.

When the controller 2 determines that the largest value of all the cosine similarities is smaller than the threshold D in step S16, the controller 2 regards the speaker as a "new speaker" and stores (registers) the input speech data or the processed input speech data acquired in step S3 and the vector of the speech data generated in step S7 or S9 in the storage as speaker information of the "new speaker" in step S17. When a plurality of "new speakers" are registered through repetition of the flow of the speech recognition method, the "new speakers" can be distinguished, for example, as a "new speaker A", a "new speaker B", a "new speaker C", and the like. When the "new speaker" is registered, in step S10 performed thereafter, the "new speaker" registered in step S17 is included in the registrants.

Then, the processing proceeds to step S18, and the controller 2 outputs the text data obtained by the speech recognition in step S4 as the speech of the "new speaker" to the user interface such as the display 11. In this case, the user can input the name of the speaker to the controller 2, or can select the name of a registrant who has already been registered, using an operation inputter such as a keyboard. When the name of the speaker is input or the name of the registrant is selected, the controller 2 corrects the display of "new speaker" on the user interface to the input name of the speaker or the selected name of the registrant.

When the name of the speaker input by the user is not registered, the controller 2 corrects the speaker information of the "new speaker" to the speaker information of the speaker with the name input by the user.

When the name of the speaker input by the user has already been registered or when the user selects the name of a registrant who has already been registered, the controller 2 integrates the speaker information of the "new speaker" into the speaker information of the registrant (speaker integration step).

Then, the processing returns to step S1.

### Second Embodiment

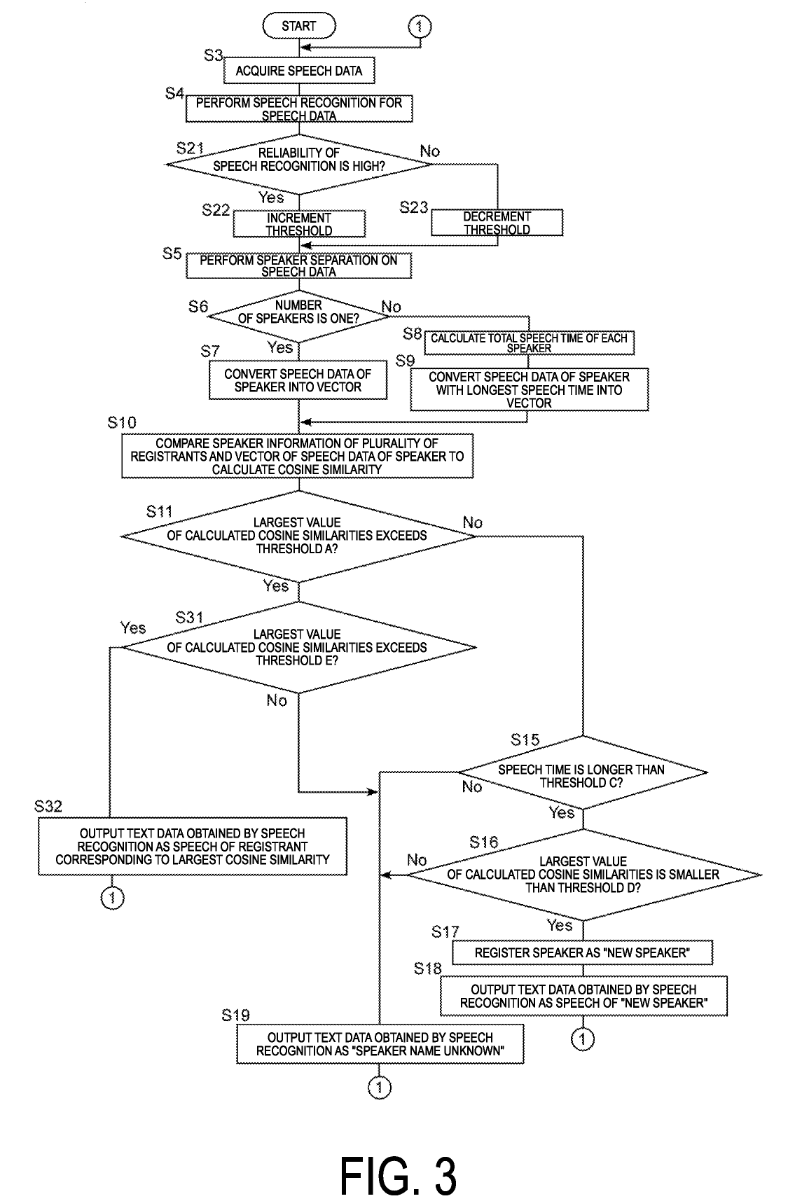

FIG. 3 is a flowchart of a speech recognition method of a second embodiment.

The speech recognition method of the second embodiment is the same as the speech recognition method of the first embodiment except that steps S1 and S2 are not performed, steps S21, S22, and S23 are performed, and steps S31 and S32 are performed instead of steps S12 to S14. In the second embodiment, step S21 is the reliability determination step, steps S22 and S23 are adjustment steps, and steps S7, S9 to S11, S16, S31, and the like are included in the identification step.

Since steps S3, S4, S5 to S11, and S15 to S19 have been described in the first embodiment, the description thereof will be omitted here, and steps S21 to S23 and steps S31 and S32 will be mainly described.

After the speech recognition is performed in step S4 described in the first embodiment, the controller 2 determines whether the reliability of the speech recognition performed in step S4 is high in step S21. In step S21, the controller 2 can determine whether the reliability of the speech recognition is high based on the results of filter processing such as speech determination (VAD determination), language determination, determination on certainty of recognition results, and text shaping (removing hallucination such as symbols) performed in the speech recognition processing in step S4. For example, the reliability of the speech recognition is considered to be high when the speech is clearly input to the microphone 10. The reliability of the speech recognition is considered to be low when the speech is not clearly input to the microphone 10.

When the controller 2 determines that the reliability of the speech recognition is high in step S21, the controller 2 (adjuster 4) increments the threshold A used in step S11 in step S22 or does not change the threshold A when the threshold A is already a high value. In this case, the controller 2 (adjuster 4) can increment the threshold D used in step S16 and/or increment the threshold E used in step S31, or does not change the threshold D and/or the threshold E when the thresholds are already high values. With this configuration, speaker identification accuracy can be improved.

When the controller 2 determines that the reliability of the speech recognition is low in step S21, the controller 2 (adjuster 4) decrements the threshold A used in step S11 in step S23 or does not change the threshold A when the threshold A is already a low value. In this case, the controller 2 (adjuster 4) can decrement the threshold D used in step S16 and/or decrement the threshold E used in step S31, or does not change the threshold D and/or the threshold E when the thresholds are already low values.

When the reliability of the speech recognition is low, the accuracy of similarity determination is low, and the similarity is low even for speech of the same speaker. Still, by using a low threshold, it is possible to suppress registration of an already registered speaker as a "new speaker" in step S17.

After the controller 2 adjusts the thresholds in steps S22 and S23, the controller 2 performs speaker separation on the input speech data or the processed input speech data in step S5. The details of step S5 have been described in the first embodiment, and thus the description thereof will be omitted here.

When the controller 2 determines that the largest value of all the cosine similarities exceeds the threshold A in step S11 described in the first embodiment, the controller 2 can determine whether the largest value of all the cosine similarities exceeds the threshold E in step S31. The threshold E may be a value higher than the threshold A, and may be set to a value higher than the smallest value of a range of the cosine similarities with which the speaker of the input speech data or the processed input speech data can be regarded as the same person as the registrant. With this configuration, speaker identification accuracy can be improved.

When the controller 2 determines that the largest value of all the cosine similarities exceeds the threshold E in step S31, the controller 2 outputs the text data obtained by the speech recognition in step S4 as the speech of the registrant corresponding to the largest cosine similarity to the user interface such as the display 11 in step S32. Specifically, both the name of the registrant corresponding to the largest cosine similarity and the text data obtained by the speech recognition in step S4 can be displayed on the display 11. Then, the processing returns to step S1.

When the controller 2 determines that the largest value of all the cosine similarities is smaller than the threshold E in step S31, the controller 2 outputs the text data obtained by the speech recognition in step S4 as "speaker name unknown" to the user interface such as the display 11 in step S19. The details of step S19 have been described in the first embodiment, and thus the description thereof will be omitted here.

The description of the first embodiment described above also applies to the second embodiment as long as there is no contradiction.

### Third Embodiment

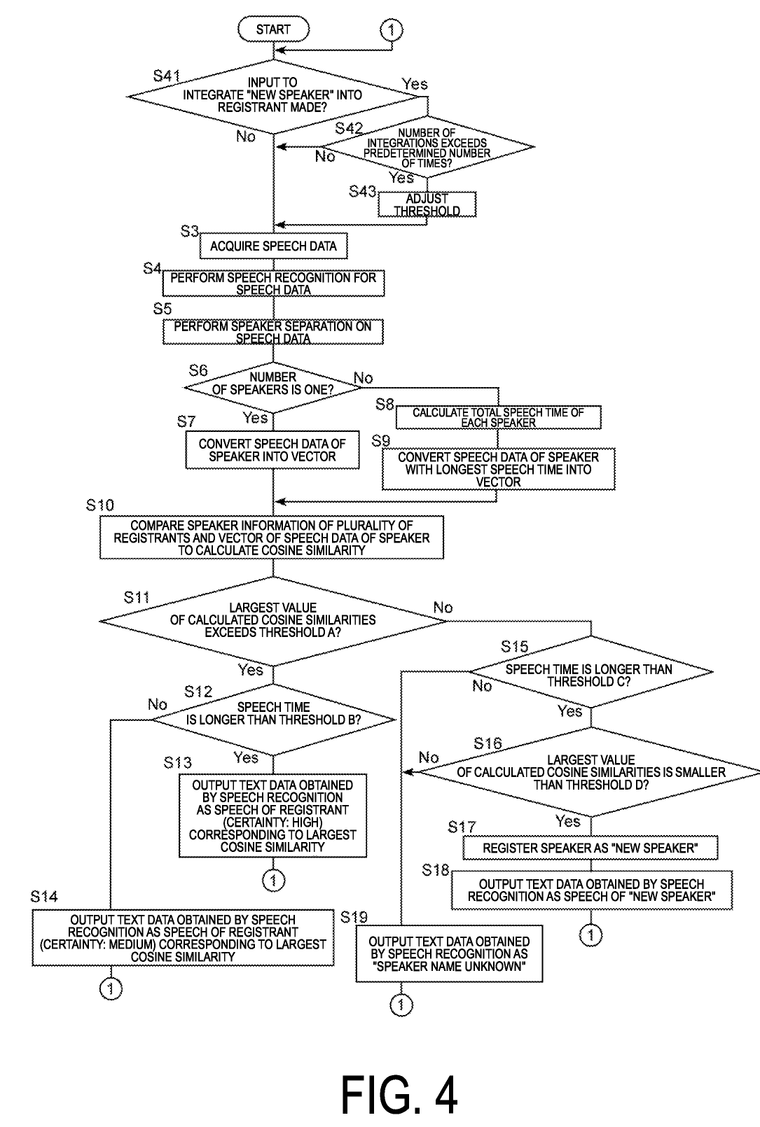

FIG. 4 is a flowchart of a speech recognition method of a third embodiment.

The speech recognition method of the third embodiment is the same as the speech recognition method of the first embodiment except that steps S1 and S2 are not performed and steps S41 to S43 are performed. In the third embodiment, step S43 is the adjustment step, and for example, steps S7, S9 to S11, S16, and the like are included in the identification step.

Since steps S3 to S19 have been described in the first embodiment, the description thereof will be omitted here, and steps S41 to S43 will be mainly described.

In step S41, the controller 2 determines whether an input has been made by the user to integrate the speaker information of the "new speaker" registered in step S17 into the speaker information of the registrant. The integration of the speaker information is as described in step S18 of the first embodiment.

When the controller 2 determines that the input has not been made by the user to integrate the speaker information in step S41, the processing proceeds to step S3 where the controller 2 acquires the speech data.

When the controller 2 determines that the input has been made by the user to integrate the speaker information in step S41, the controller 2 determines whether the number of integrations exceeds a predetermined number of times in step S42. Specifically, the controller 2 determines whether the speaker integration has been performed a given number of times (for example, three times) during a given time period (for example,10 minutes). When the number of integrations is large, the number of times that the speech of the registrant has been determined to be the speech of a new speaker is considered to be large.

When the controller 2 determines that the number of integrations does not exceed the predetermined number of times in step S42, the processing proceeds to step S3 where the controller 2 acquires the speech data.

When the controller 2 determines that the number of integrations exceeds the predetermined number of times in step S42, the controller 2 (adjuster 4) adjusts the threshold A used in step S11 and/or the threshold D used in step S16, in step S43. Specifically, the controller 2 can set the threshold A and/or the threshold D to be low. As a result, a registrant who has already been registered is less likely to be registered as a "new speaker", whereby registration accuracy is improved.

Then, the processing proceeds to step S3, where the controller 2 acquires the speech data.

The description of the first embodiment described above also applies to the third embodiment as long as there is no contradiction.

### Fourth Embodiment

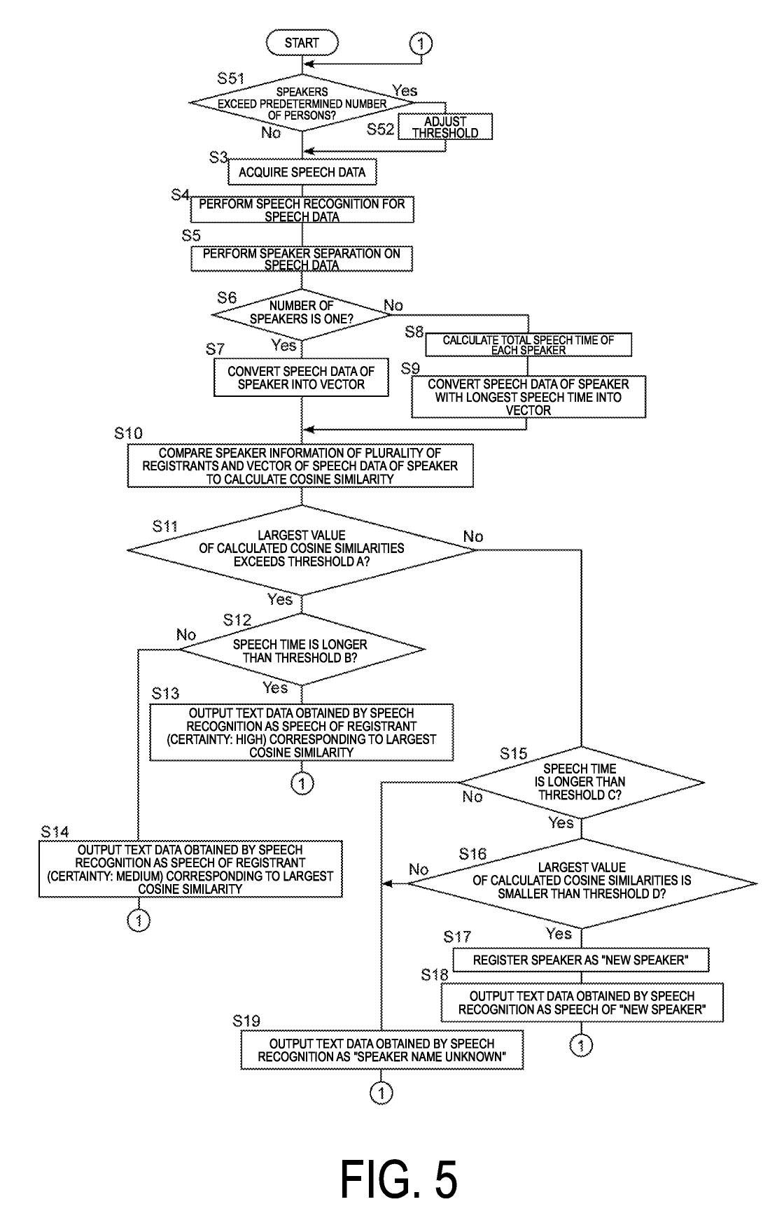

FIG. 5 is a flowchart of a speech recognition method of a fourth embodiment.

The speech recognition method of the fourth embodiment is the same as the speech recognition method of the first embodiment except that steps S1 and S2 are not performed and steps S51 and S52 are performed. In the fourth embodiment, step S52 is the adjustment step, and for example, steps S7, S9 to S11, S16, and the like are included in the identification step.

Since steps S3 to S19 have been described in the first embodiment, the description thereof will be omitted here, and steps S51 and S52 will be mainly described.

In step S51, the controller 2 determines whether the number of speakers exceeds a predetermined number of persons. Specifically, the controller 2 determines whether the number of speakers (registrants and "new speakers") output together with the text data in steps S13, S14, and S18 exceeds a predetermined number of persons (for example, 10). When a "new speaker" is integrated into the registrant, the "new speaker" is not added to the number of persons.

When the controller 2 determines that the number of speakers does not exceed the predetermined number of persons in step S51, the processing proceeds to step S3 where the controller 2 acquires the speech data.

When the controller 2 determines that the number of speakers exceeds the predetermined number of persons in step S51, the controller 2 (adjuster 4) adjusts the threshold A used in step S11 and/or the threshold D used in step S16, in step S52. Specifically, the controller 2 can set the threshold A and/or the threshold D to be high.

When the number of speakers is large, the controller 2 is more likely to acquire speech data of speech of speakers (registrants and "new speaker"), speeches of which are of high similarity. Therefore, with the controller 2 setting the threshold A and/or the threshold D to be high in step S52, it is possible to prevent different speakers from being determined to be the same speaker, whereby the registration accuracy is improved.

Then, the processing proceeds to step S3, where the controller 2 acquires the speech data.

The description of the first embodiment described above also applies to the fourth embodiment as long as there is no contradiction.

While there have been described what are at present considered to be certain embodiments of the invention, it will be understood that various modifications may be made thereto, and it is intended that the appended claim cover all such modifications as fall within the true spirit and scope of the invention.

What is claimed is:

1. A speech recognition method comprising:
an input speech data acquisition step of acquiring input speech data;
an adjustment step of adjusting a first threshold based on a predetermined condition; and
an identification step of comparing the input speech data or processed input speech data generated by processing the input speech data with registered speech data of speech of registrants registered in advance to calculate similarities for the respective registrants, and identifying which of the registrants registered in advance has made a speech corresponding to the input speech data or the processed input speech data based on the similarities,
wherein the identification step includes registering the speaker of the input speech data or the processed input speech data as a new speaker when a largest value of the similarities calculated for the respective registrants is determined to be lower than the first threshold.

2. The speech recognition method according to claim 1,
wherein the identification step is a step of comparing a numerical vector obtained by converting a feature of the input speech data or the processed input speech data with a numerical vector obtained by converting the registered speech data to calculate the similarities for the respective registrants, and identifying which of the registrants registered in advance has made the speech corresponding to the input speech data or the processed input speech data based on the similarities, and a step of registering the speaker of the input speech data or the processed input speech data as a new speaker when the largest value of the similarities calculated for the respective registrants is determined to be lower than the first threshold.

3. The speech recognition method according to claim 1 further comprising
an operation detection step of detecting an operation of adjusting the first threshold by a user,
wherein the adjustment step includes adjusting the first threshold based on the operation of adjusting the first threshold by the user.

4. The speech recognition method according to claim 1 further comprising
a reliability determination step of determining reliability of speech recognition for the input speech data or the processed input speech data,
wherein the adjustment step includes automatically adjusting the first threshold according to the reliability of the speech recognition.

5. The speech recognition method according to claim 1 further comprising
a running time determination step of determining whether a running time of the input speech data or a running time of the processed input speech data is longer than a second threshold,
wherein the speaker of the input speech data or the processed input speech data is registered as a new speaker when the running time of the input speech data or the running time of the processed input speech data is determined to be longer than the second threshold in the determination step, and when the largest value of the similarities calculated for the respective registrants is determined to be lower than the first threshold in the identification step.

6. The speech recognition method according to claim 1,
wherein the identification step includes determining the speaker of the input speech data or the processed input speech data to be unknown when the largest value of the similarities calculated for the respective registrants is higher than the first threshold and lower than a third threshold, and identifying the speaker of the input speech data or the processed input speech data as the registrant with the similarity of the largest value when the largest value of the similarities calculated for the respective registrants is higher than the third threshold.

7. The speech recognition method according to claim 6 further comprising
a reliability determination step of determining reliability of speech recognition for the input speech data or the processed input speech data,
wherein the adjustment step includes automatically adjusting the first threshold and the third threshold according to the reliability of the speech recognition.

8. The speech recognition method according to claim 1,
wherein the processed input speech data is data generated by removing speech data of a silent part from the input speech data.

9. The speech recognition method according to claim 1 further comprising
a speaker integration step of integrating the new speaker into the registrants registered in advance,
wherein the adjustment step includes automatically adjusting the first threshold to decrement the first threshold when number of times of integrating the new speaker into the registrants registered in advance exceeds a predetermined number of times.

10. A speech recognition apparatus comprising:
an input speech data acquirer that acquires input speech data;
an adjuster that adjusts a first threshold based on a predetermined condition; and
an identifier that compares the input speech data or processed input speech data generated by processing the input speech data with registered speech data of speech of registrants registered in advance to calculate similarities for the respective registrants, and identifies which of the registrants registered in advance has made a speech corresponding to the input speech data or the processed input speech data based on the similarities,
wherein the identifier registers the speaker of the input speech data or the processed input speech data as a new speaker when a largest value of the similarities calculated for the respective registrants is determined to be lower than the first threshold.
